(19) United States
(12) Patent Application Publication
(10) Pub. No.: US 2014/0332111 A1
(43) Pub. Date: Nov. 13, 2014

(54) Reinforcing Assembly for Air Conditioning Ducts and Reinforced Air Conditioning Duct Incorporating Such Assembly

(71) Applicant: PRIHODA s.r.o., Hlinsko (CZ)

(72) Inventor: Zdenek Prihoda, Hlinsko (CZ)

(73) Assignee: PRIHODA S.R.O., Hlinsko (CZ)

(21) Appl. No.: 14/270,754

(22) Filed: May 6, 2014

(30) Foreign Application Priority Data
May 7, 2013 (CZ) 2013-335

(51) Int. Cl. F16L 9/04

(52) U.S. Cl. CPC F16L 9/04
USPC 138/172

(57) ABSTRACT

A reinforcing assembly for an air conditioning duct comprises a plurality of annular elements having outer circumferences configured to define an inner cross section of the conditioning duct, at least three interconnecting cords for linking the outer circumferences of the annular elements in a series, and fixing means for securing the positions of the annular elements relative to the interconnecting cords.

### FIELD OF THE INVENTION

The present invention relates to a reinforcing assembly for air conditioning ducts and to an air conditioning duct incorporating such reinforcing assembly. The reinforcing assembly comprises annular elements, the outer circumferences thereof defining the inner circumference of the air conditioning duct to be reinforced, and to an air conditioning duct incorporating such reinforcing assembly.

### BACKGROUND ART

Known air conditioning ducts, which constitute the prior art concerned and serve for transporting or distributing air, are typically made of woven or non-woven fabrics or foils. The pipes making up such ducts, also referred to as textile inlets and outlets, are typically made of a material sewn together so as to form a closed shape having a specific cross section. Usually, a circular cross section is used, such as that described in the utility model No. CZ13658. Alternatively, the cross section may assume a form of a circular sector or by any combination of such sectors. Recently, textile ducts having square or triangular cross sections have been launched into the market, such as those disclosed in the utility model No. CZ21618. The duct may be perforated to a certain extent, the air distribution taking place either through such perforation or through the material itself, provided that the latter is pervious to air. Such ducts are then attached fixed by means of a suitable mounting system to parts of a building.

A certain drawback of the above mentioned inlets/outlets and ducts is their shape instability. When the respective fan or blower is switched off, the duct deflates. Manufacturers have incorporated various reinforcements in order to prevent distortion caused by such deflation. The use of such reinforcements, however, is not widespread because the reinforcing elements are expensive and must be removed from the duct before washing, as well as replaced after washing. In particular, the insertion of each individual reinforcing element into the corresponding pocket of the respective air conditioning duct is very time-consuming from the user's point of view. An example of a reinforcing assembly for an air conditioning duct is also described in WO 2012091795. Another significant disadvantage of the above mentioned reinforcements as well as of other ordinary ones consists in that that they make the transport more complicated because they are considerably cumbersome. While the duct itself can be shipped in the folded state inside a cardboard box and undergo a long-distance transport, the rigid reinforcements and their sturdy fastening elements considerably increase both the weight of the respective shipment and the spatial demands during transportation.

### SUMMARY OF THE INVENTION

The above disadvantages of prior art are eliminated to a large extent by a reinforcing assembly for air conditioning ducts, the assembly comprising:
annular elements having outer circumferences configured to define an inner cross section of an air conditioning duct to be reinforced,
at least three interconnecting cords, which link the outer circumferences of the annular elements in a series,
and fixing means for securing the positions of the annular elements relative to the interconnecting cords.

According to an embodiment the annular elements are provided with through holes, through which the interconnecting cords are guided, and the fixing means are strung on the interconnecting cords and adaptable to prevent the annular elements from sliding along the interconnecting cords.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 is a perspective view showing a reinforcing assembly attached to a bracket, the respective air conditioning duct not being shown.

FIGS. 2A-2C show the details A, B, and C from FIG. 1.

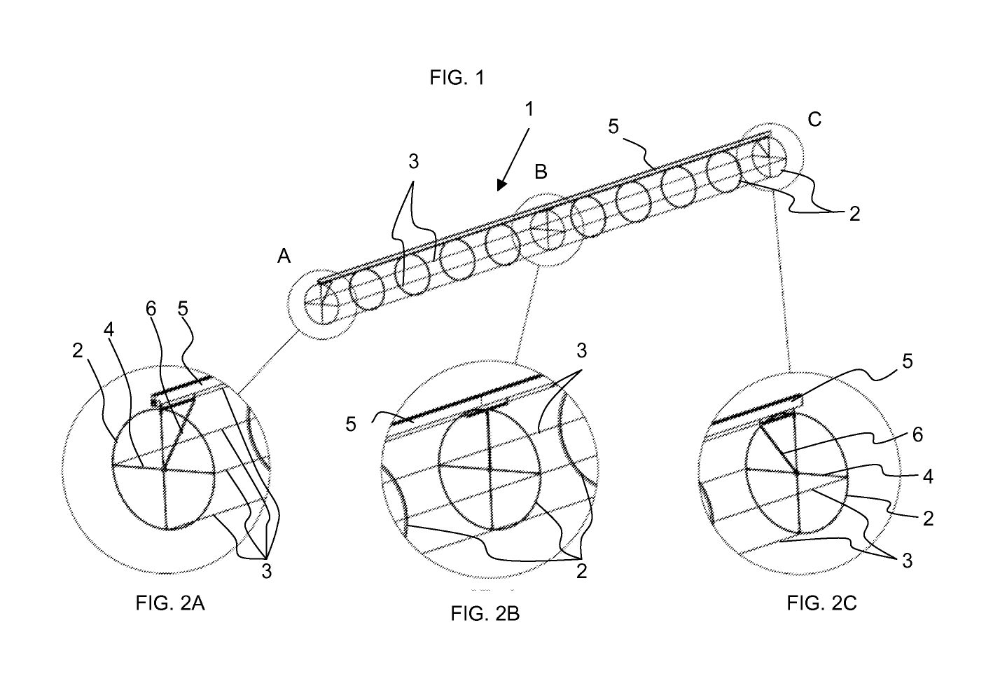

### DETAILED DESCRIPTION

An embodiment of a reinforcing assembly 1 according to the present invention comprises an array of annular elements 2, a system of interconnecting cords 3 (such as flexible wires or ropes, for example) and a bracket 5. The annular elements 2 are arranged consecutively in a row and linked by the interconnecting cords 3. The first, middle and last annular elements 2 of the row are stiffened by cross-shaped braces 4 and are preferably made of a material that is more rigid than that used for the remaining annular elements 2.

Each of the annular elements 2 that is reinforced by the cross-shaped braces 4 is provided with a fastener (not shown) for securing the respective annular element 2 to the bracket 5. Preferably, the bracket 5 is provided with a groove extending along the bracket 5 so that the annular element 2 can be suspended via its fastener from the bracket 5, the fastener being slidably guided within the groove. After reaching the desired position, the annular element 2 can be locked.

One of ordinary skill will appreciate that the cross-shaped brace 4 can be replaced with a different brace having any suitable shape. Alternatively, the stiffening brace 4 may be entirely left out, provided that the material characteristics and/or the cross-section of the annular element 2 render the annual element 2 sufficiently sturdy.

In the embodiment shown, every two adjacent annular elements 2 are linked by four interconnecting cords 3 attached to the respective annular elements 2 at four points, the points being uniformly angularly spaced so that the interconnecting cords 3, once installed, extend in parallel to each other. The interconnecting cords 3 have equal lengths so that the annular elements 2 are arranged in planes that are substantially perpendicular to a longitudinal centerline of the bracket 5. Moreover, the annular elements 2 are uniformly spaced.

The interconnecting cords 3 may be attached to the annular elements 2 by fixing means (not shown), such as by hooks and loops or snap-hooks and lugs. The loops or lugs are arranged on the annular elements 2, and the hooks or snap-hooks, respectively, are arranged at the ends of interconnecting cords 3, or vice versa.

According to an embodiment, the annular elements 2 are provided with through holes (not shown), through which the interconnecting cords 3 are guided. Each interconnecting cord 3 is provided with at least one fixing means arranged on it between the respective two adjacent annular elements 2 for securing the annular elements 2 in their positions on the interconnecting cord 3 or for preventing the annular elements 2 from sliding along the interconnecting cord 3. The fixing means may comprise, for example, a fixing clamp, clip or cord lock, for securing the annular elements 2 in their positions on the interconnecting cord 3 or for preventing the annular elements 2 from sliding along the interconnecting cord 3. Preferably, two fixing means may be arranged on each interconnecting cord 3 between every two adjacent annular elements 2 or on both sides of each annular element 2.

The fixing means may also be formed by a deformable tube which has an outer diameter greater than the inner diameters of the through holes provided in the annular elements 2 for guiding the interconnecting cords 3. The tube may be composed of aluminium, for example. The tube can be strung on the respective interconnecting cord 3. After being correctly positioned, the deformable tube is squeezed, preferably in a point spaced from, but near to the edge adjoining the through hole in the adjacent annular element 2. Thus, the tube is secured in the desired position on the interconnecting cord 3 in order to prevent the annular element 2 from sliding along the interconnecting cord 3.

It is also possible to have the fixing means arranged on two interconnecting cords 3 only, preferably on two diametrically opposed ones.

According to another embodiment, every two adjacent annular elements 2 are linked together by means of a triplet of interconnecting cores, each annular element 2 being provided with three angularly spaced attachment points, the angular spacing being preferably uniform. In contrast to that, an assembly according to an alternative embodiment comprises more ropes for interconnecting adjacent annular elements 2.

In the embodiment shown, the annular elements 2 have a circular shape, but they could also assume another shape, such as a semicircular, triangular or rectangular shape. It is desirable that all the annular elements 2 arranged in a particular set have identical outer circumferential shape or that their outer circumferences match with the inner circumferential shape or cross section of the respective air conditioning duct. In other words, the outer circumferences of the annular elements 2 define the inner cross section of the air conditioning duct. If the reinforcing assembly 1 is intended to be used in an air conditioning duct having one portion different in the inner circumference or shape from another portion, the sizes and shapes, respectively, of the corresponding annular elements 2 should be adapted accordingly.

The embodiment that is shown herein is based on the assumption that most of the annular elements 2 are made of aluminium or an alloy thereof. However, those annular elements 2, which are stiffened by means of the cross-shaped braces 4 (i.e., the annular elements located at the inlet and outlet ends as well as in the middle of the respective portion of the air conditioning duct) are preferably made of steel. Alternatively, the annular elements may be made of a composite plastic or another suitable material. In general, it is desirable that particularly the front-end and terminal annular elements 2 in a row are stiffer than the remaining annular elements 2, which should be not only sufficiently stiff but also lightweight. The interconnecting cords 3 are preferably made of steel (such as stranded wires having about 1 mm in diameter). Alternatively, the interconnecting cords may be made of natural or synthetic fibres.

As indicated in the accompanying drawing, at least the first and the last annular elements 2 arranged in a particular set are preferably attached to the bracket 5. If the distance between the first annular element and the last one is relatively long, one of the intermediate annular elements 2 should be attached to the bracket 5, as well. In this manner, the assembly can be prevented from slacking between its first and last annular elements.

The bracket 5 is arranged outside the air conditioning ductwork (not shown), the latter being suitably adapted for the installation of fasteners passing through the same and serving for securing the reinforcing assembly 1, or at least two of the multiple annular elements 2 making up the assembly, to the bracket 5. With respect to the embodiment shown, the air conditioning ductwork is provided with three openings, through which the fasteners can pass, the openings being arranged in the inlet, intermediate and outlet portions of the duct, respectively. In order to avoid excessive air leaks in the areas where the above openings are formed, the openings may be sealable, for example, by flaps provided with hook-and-loop closures. Because most of the annular elements 2 do not need to be secured to the bracket 5, it is not necessary to adapt the air conditioning ductwork in order to accommodate the fastener of each annular element 2.

The positions of the annular elements 2 within a plane, which extends perpendicularly to the longitudinal centerline of the bracket 5, are secured in that the annular elements 2 arranged in the inlet and outlet portions of the respective duct are respectively provided with supporting elements 6, which help prevent the annular elements 2 from tilting relative to the bracket 5. In the embodiment shown, one end of the supporting element 6 is attached to a center of the respective cross-shaped brace 4 and the other end of the supporting element 6 is removably attached to the bracket 5 at an attachment point. The attachment point is sufficiently spaced from the point where the respective annular element 2 is secured to the bracket 5. Alternatively, the attachment point 6 may be more distant or, as the case may be, at the most distant point from where the annular element 2 is secured to the bracket 5. In another embodiment, the supporting element 6 may be formed as an L-shaped piece having its one side attached to the respective annular element 2 and extending along the plane defined by the annular element 2 and its other side attached to the bracket 5 and extending parallel to the longitudinal centerline of the plane.

Alternatively, the positions of the annular elements 2 within a plane, which extends perpendicularly to the longitudinal centerline of the bracket 5, may be secured in that the ends of the interconnecting cords 3 are attached to a common point on the bracket 5 or to another suitable point located in front of the inlet end of the air conditioning duct, in which the respective reinforcing assembly 1 is arranged, such attachment point being sufficiently spaced from the first annular element 2. Thus, the interconnecting cords 3 can act as tie rods.

Owing to the use of the annular elements 2 and to the spacing of the same, the shape of the reinforced air conditioning duct can be maintained even during periods of time when a respective fan or blower is switched off or during potential pressure drops in the ductwork. In such situations, the arrangement of the interconnecting cords 3 along the duct walls also contribute to maintenance of the shape of the duct between the individual annular elements 2.

The functionality of the reinforcing assembly 1 remains unchanged without necessitating any adjustments or modifications even when the respective air conditioning duct must extend along an arcuate path, such as when an arcuate bracket 5 having a large radius of curvature must be used. If the radius of curvature of the bracket 5 is smaller, it will be preferable to use a segmented air conditioning duct provided with annular elements 2 arranged at either end of each of the segments that make up the arcuate portion of the duct.

In general, the lengths of the interconnecting cords 3 arranged between every two adjacent annular elements 2 will be identical, except in case that the reinforcing assembly 1 is adapted for an air conditioning duct extending along an arcuate or segmented path. In the latter case, the interconnecting cords 3 will be shorter in an area of an inner curvature than in an area of an outer curvature.

During installation, first the reinforcing assembly 1 is put together with all the annular elements 2 arranged in a row, the interconnecting cords 3 remaining slackened but being in fixed positions relative to the respective annular elements 2. Once so prepared, the reinforcing assembly 1 is inserted into the air conditioning duct through one of the ends of the duct. The reinforcing assembly 1 is then unfolded along the entire length of the air conditioning duct and, subsequently, the fasteners are attached to the bracket 5, and at least the outer annular elements 2 are secured in position by means of the respective supporting elements 6.

Preferably, the interconnecting cords 3 and/or the air conditioning duct are then tightened and anchored to a fixed support.

1. A reinforcing assembly for an air conditioning duct, the assembly comprising:
a plurality of annular elements having outer circumferences configured to define an inner cross section of the air conditioning duct;
at least three interconnecting cords for linking the outer circumferences of the annular elements in a series; and
fixing means for securing positions of the annular elements relative to the interconnecting cords.

2. The reinforcing assembly of claim 1, wherein the annular elements are provided with through holes configured to have the interconnecting cords guided therethrough.

3. The reinforcing assembly of claim 1, wherein every two adjacent annular elements in the series are linked together by at least three interconnecting cords.

4. The reinforcing assembly of claim 2, wherein the fixing means are coupled to the interconnecting cords and are configured to prevent the annular elements from sliding along the interconnecting cords.

5. The reinforcing assembly of claim 4, wherein the fixing means comprise at least one of hooks, loops, clamps, clips, and cord locks.

6. The reinforcing assembly of claim 4, wherein the fixing means comprise deformable tubes strung on the interconnecting cords.

7. The reinforcing assembly of claim 1, wherein at least one of the annular elements is stiffened by a brace.

8. The reinforcing assembly of claim 1, wherein at least one of the annular elements is made of a material having higher strength than that of the remaining annular elements of the reinforcing assembly.

9. The reinforcing assembly of claim 1, further comprising:
a bracket; and
at least two fasteners for securing the first and the last annular elements in the series to the bracket.

10. The reinforcing assembly of claim 9, further comprising:
at least one supporting element configured to stabilize at least one of the annular elements.

11. The reinforcing assembly of claim 10, wherein the at least one supporting element is configured to stabilize the at least one of the annular elements within a plane extending perpendicularly to a longitudinal centerline of the bracket.

12. An air conditioning duct comprising:
a reinforcing assembly comprising:
a plurality of annular elements having outer circumferences configured to define an inner cross section of the air conditioning duct;
at least three interconnecting cords for linking the outer circumferences of the annular elements in a series; and
fixing means for securing positions of the annular elements relative to the interconnecting cords.

13. The air conditioning duct of claim 12, wherein the annular elements are provided with through holes configured to have the interconnecting cords guided therethrough.

14. The air conditioning duct of claim 13, wherein the fixing means are coupled to the interconnecting cords and are configured to prevent the annular elements from sliding along the interconnecting cords.
